(19) United States
(12) Patent Application Publication
(10) Pub. No.: US 2013/0343454 A1
(43) Pub. Date: Dec. 26, 2013

(54) METHOD AND AN APPARATUS FOR CODING AN IMAGE

(71) Applicants: Chuohao Yeo, Singapore (SG); Yih Han Tan, Singapore (SG); Zhengguo Li, Singapore (SG)

(72) Inventors: Chuohao Yeo, Singapore (SG); Yih Han Tan, Singapore (SG); Zhengguo Li, Singapore (SG)

(73) Assignee: AGENCY FOR SCIENCE, TECHNOLOGY AND RESEARCH, Singapore (SG)

(21) Appl. No.: 13/978,444

(22) PCT Filed: Jan. 6, 2012
(86) PCT No.: PCT/SG2012/000009

§ 371 Date: Sep. 16, 2013

Related U.S. Application Data
(60) Provisional application No. 61/430,557, filed on Jan. 7, 2011.

(51) Int. Cl. H04N 7/34

(52) U.S. Cl. CPC H04N 19/00763
USPC 375/240.03; 375/240.12

(57) ABSTRACT

The present invention is directed to a method for coding an image, comprising generating from the image a residual block having a plurality of residual values using a coding mode; selecting a scanning pattern for scanning the residual block depending on the coding mode; scanning the residual values according to the scanning pattern; and generating a residual value stream from the scanned residual values. The present invention is also directed to a method of initializing a scanning pattern for coding an image, the method comprising collecting information on a coding mode applied to a residual block having a plurality of residual values; and assigning a directional scan in response to the information to form the scanning pattern. Apparatus for coding an image and for initializing a scanning pattern for coding an image are also disclosed.

### CROSS-REFERENCE TO RELATED APPLICATION

This application makes reference to and claims the benefit of priority of an application for “Mode-Dependent Coefficient Scanning for Intra Prediction Residual Coding” filed on Jan. 7, 2011 with the United States Patent and Trademark Office, and there duly assigned application No. 61/430,557. The content of said application filed on Jan. 7, 2011 is incorporated herein by reference for all purposes, including an incorporation of any element or part of the description, claims or drawings not contained herein and referred to in Rule 20.5(a) of the PCT, pursuant to Rule 4.18 of the PCT.

### TECHNICAL FIELD

Various embodiments generally relate to the field of image coding, in particular, intra prediction residual coding.

### BACKGROUND

H.264/AVC is the current video coding standard, and has been widely adopted due to its high coding efficiency and interoperability conferred by its status as a joint standard established by ISO/IEC MPEG (Moving Picture Experts Group) and ITU-T VCEG (Video Coding Experts Group).

H.264/AVC uses spatial (intra) predictions and/or temporal (inter) predictions to increase coding gain. A technical area of focus is intra-frame coding, in which frames are compressed without any temporal dependencies, that is to say, intra-frame coding is performed using a single frame or image. Even though a typical compressed video may contain only a small fraction of intra-frames, because of their lower compression efficiency compared to inter-frames, intra-frames still take up a significant portion of the overall rate.

An approach towards reducing intra-coding rate is to improve the performance of intra prediction residual coding. A frame from a video sequence is first partitioned into macroblocks or blocks. In a typical intra-coding pipeline, a prediction of a source block is formed using its neighbouring reconstructed pixels. Then, the prediction (predictive block) is subtracted from the source block to form the prediction residual. This residual is then transform coded, quantized, and then entropy coded as shown in FIG. 1, illustrating the intra-coding pipeline.

Decoding of the encoded video signal by a decoder can be performed substantially in a reverse process.

In H.264/AVC, two entropy coders can be used. One is an arithmetic coding based Context-based Adaptive Binary Arithmetic Coder (CABAC), while the other is a variable length coding (VLC) based Context Adaptive Variable Length Coding (CAVLC).

Within CABAC, entropy coding of transform coefficients takes place in two stages. In the first stage, a significance map, which signals where non-zero coefficients within block are located, is coded. In the second stage, the values of the non-zero transform coefficients are coded. FIG. 2 shows an exemplary illustration of entropy coding of transform coefficients in CABAC.

Coding of the significance map proceeds by going over each coefficient, and signalling whether it is significant or not. If it is signalled to be significant, then a second flag is coded to signal if it is the last significant coefficient. If it is, then coding of the significance map stops, since the rest of the coefficients is implied to be zero. Therefore, it is beneficial to scan from the coefficient most likely to be non-zero to the coefficient least likely to be non-zero, since this would avoid coding unnecessary “zero coefficient” flags.

The Joint Collaborative Team on Video Coding (JCT-VC) formally established a HEVC test model (HM) in the 3rd JCT-VC meeting in Guangzhou, China. In this HM model, the mechanism for coding of the significance map in CABAC starts with scanning diagonally, from the top-left diagonal to the bottom-right diagonal, as shown in FIG. 3. Within each diagonal, the scan can proceed towards the bottom-left (“down-left”), or towards the top-right (“up-right”). The actual choice of direction is adaptive. After coding each diagonal, the number of significant coefficients already coded in the upper-right half and the number of significant coefficients already coded in the lower-left half is compared. If the former is larger, then the scan direction for the next diagonal is down-left, and if the latter is larger, then the scan direction for the next diagonal is up-right. If the former and the latter are the same, then the previous scan direction is retained.

In this approach, two counters need to be maintained to keep track of the number of significant coefficients in the upper-right half and the lower-left half, and at the end of coding each diagonal, a decision needs to be made as to which scan direction is used next. This increases decoding complexity. Further, due to the context modelling used for coding the significance flag for each coefficient, there are some difficulties in parallelizing coding of the scans.

Mode-dependent adaptive scan orders have been used to improve coding efficiency. This approach has two main parts. First, the scan order used to code the significance map depends on the intra prediction mode that has been signalled. In other words, instead of zig-zag scans or the scan described above, an arbitrary and different scan is adopted for each prediction mode. Second, the scan order is adaptive. During encoding and decoding, the frequency of non-zero coefficients at each block location is tracked, and is used to update the scan order after encoding/decoding each block. FIG. 4 shows an example of an arbitrary scan order and its corresponding frequency statistics.

As this approach aims to scan coefficients from largest to smallest based on collected statistics, it is able to improve coding performance, as many zero coefficients can avoid being signalled when coding the significance map.

However, this approach requires collecting the frequency statistics and updating the scan order on a per-block basis, which can drastically increase decoding complexity, since sorting of the frequency to derive the scan order needs to be done. Additionally, the resulting arbitrary scan order makes it difficult to parallelize the coding operations. Also, a large amount of memory is needed to store the initial scan statistics, as well as the derived scan order, especially for large block sizes.

As the industry looks beyond high-definition (HD) resolutions of 1920×1080 and beyond, e.g., up to 8K×4K, a new video coding standard is necessary, in part to address the different statistics due to different resolutions and types of capturing devices as compared to H.264/AVC.

Thus, there is a need to provide a method and an apparatus for coding intra prediction residuals, seeking to address at least the problems mentioned such that the rate-distortion performance of coding an image, more specifically, intra prediction residuals are improved and for incorporation as a new “High-Efficiency Video Coding” (HEVC) standard.

### SUMMARY OF THE INVENTION

In a first aspect, the present invention relates to a method for coding an image, comprising generating from the image a residual block having a plurality of residual values using a coding mode; selecting a scanning pattern for scanning the residual block depending on the coding mode; scanning the residual values according to the scanning pattern; and generating a residual value stream from the scanned residual values.

In a second aspect, the present invention relates to a method of initializing a scanning pattern for coding an image, the method comprising collecting information on a coding mode applied to a residual block having a plurality of residual values; and assigning a directional scan in response to the information to form the scanning pattern.

In a third aspect, the present invention relates to an apparatus for coding an image, comprising a generating circuit configured to generate from the image a residual block having a plurality of residual values using a coding mode; a selection circuit configured to select a scanning pattern for scanning the residual block generated by the generating circuit depending on the coding mode; a scanner configured to scan the residual values according to the scanning pattern selected by the selection circuit; and a stream generating circuit configured to generate a residual value stream from the residual values scanned by the scanner.

In a fourth aspect, the present invention relates to an apparatus for initializing a scanning pattern for coding an image, the apparatus comprising a collecting circuit configured to collect information on a coding mode applied to a residual block having a plurality of residual values; and an assigning circuit configured to assign a directional scan in response to the information collected by the collecting circuit to form the scanning pattern.

### BRIEF DESCRIPTION OF THE DRAWINGS

In the drawings, like reference characters generally refer to the same parts throughout the different views. The drawings are not necessarily to scale, emphasis instead generally being placed upon illustrating the principles of the invention. In the following description, various embodiments of the invention are described with reference to the following drawings, in which:

FIG. 1 shows a flow chart of an example of an intra coding pipeline;

FIG. 2 shows an exemplary illustration of entropy coding of transform coefficients in CABAC;

FIG. 3 shows an exemplary illustration of scanning used for coding a significance map (a) proceeding diagonal by diagonal from top-left (1) to bottom-right (7); (b) with a “down-left” scan; (c) with a “up-right” scan;

FIG. 4 shows an exemplary illustration of an adaptive scan order;

FIG. 5 shows a schematic overview of an encoder system, in accordance to various embodiments;

FIG. 6 shows a schematic block diagram of a method for coding an image, in accordance to various embodiments;

FIG. 7 shows an exemplary schematic representation of the relationship between a block and a video sequence, in accordance to various embodiments;

FIG. 8(a) shows an exemplary schematic representation of using a vertical intra-prediction mode, in accordance to various embodiments;

FIG. 8(b) shows an exemplary schematic representation of using a horizontal intra-prediction mode, in accordance to various embodiments;

FIG. 8(c) shows an exemplary schematic representation of a mathematical relationship using the vertical intra-prediction mode of FIG. 8(a), in accordance to various embodiments;

FIG. 8(d) shows an exemplary schematic representation of a mathematical relationship using the horizontal intra-prediction mode of FIG. 8(b), in accordance to various embodiments;

FIG. 9 shows a schematic block diagram of a method of initializing a scanning pattern for coding an image, in accordance to various embodiments;

FIG. 10 shows an exemplary representation of (a) a “up-right” scan; (b) a “down-left” scan; (c) a “vertical” scan; and (d) a “horizontal” scan, in accordance to various embodiments;

FIG. 11 shows an exemplary representation of a scan progressing between (a) a point and an adjacent point; and (b) a point and an non-adjacent point, in accordance to various embodiments;

FIG. 12 shows an exemplary schematic representation of intra-prediction modes, in accordance to various embodiments;

FIG. 13 shows a schematic block diagram of an apparatus for coding an image, in accordance to various embodiments;

FIG. 14 shows a schematic block diagram of an apparatus for coding an image, in accordance to various embodiments; and

FIG. 15 shows a schematic block diagram of an apparatus for initializing a scanning pattern for coding an image, in accordance to various embodiments.

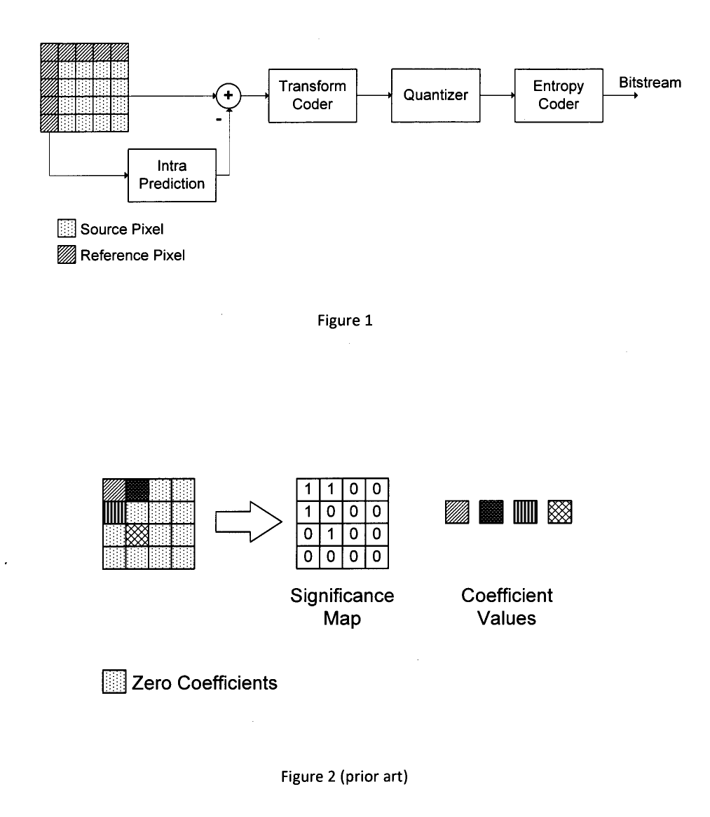

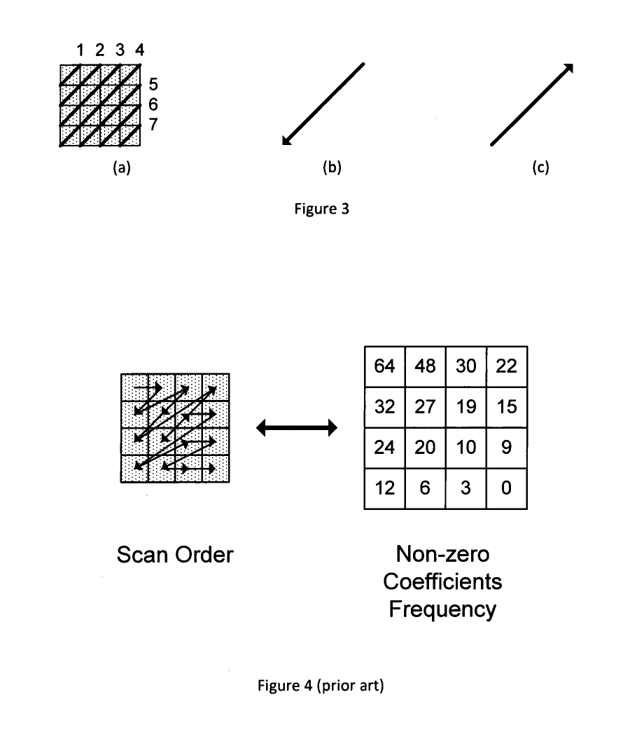

### DETAILED DESCRIPTION

The following detailed description refers to the accompanying drawings that show, by way of illustration, specific details and embodiments in which the invention may be practiced. These embodiments are described in sufficient detail to enable those skilled in the art to practice the invention. Other embodiments may be utilized and structural, and logical changes may be made without departing from the scope of the invention. The various embodiments are not necessarily mutually exclusive, as some embodiments can be combined with one or more other embodiments to form new embodiments.

In order that the invention may be readily understood and put into practical effect, particular embodiments will now be described by way of examples and not limitations, and with reference to the figures.

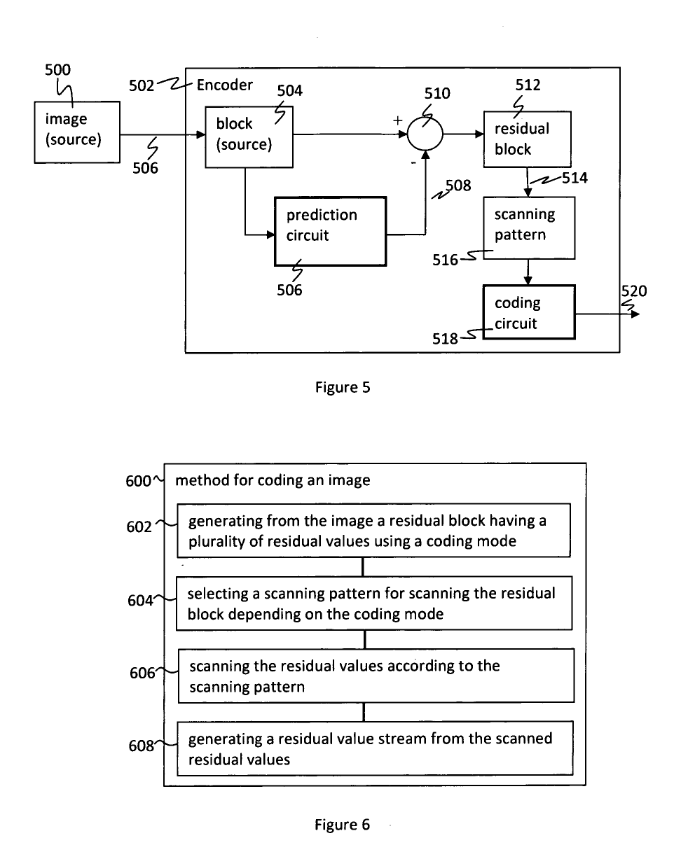

FIG. 5 shows a schematic overview of an encoder system with respect to various embodiments of the present invention. An image (source) 500 is a frame of a video sequence and is input into an encoder 502, in accordance to various embodiments. In the encoder 502, the image 500 may be sampled to obtain a block (source) 504. Sampling 506 includes dividing the image 500 into a plurality of blocks wherein each block, for example, the block 504 is encoded as follow. A coding mode, for example, a prediction mode of a prediction circuit 506 is applied to the block 504 to obtain an output 508. The block 504 and the output 508 are entered into a summer 510 which takes the difference between the block 504 and the output 508 to generate a residual block 512. The residual block 512 may be subject to transformation (not shown in FIG. 5), which may then provide another coding mode such as a parameter 514 related to the transformation of the residual block 512, for example, a transform block size. Upon transformation, the residual values may further be quantized (not shown in FIG. 5). Depending on the coding mode(s), a scanning pattern 516 is selected to scan the residual block 512 which comprises a plurality of residual values. The residual values are scanned according to the scanning pattern 516 to generate a residual value stream. The scanned residual values in a form of a residual value stream are then subject to a coding circuit 518 to generate an encoded video signal 520.

In a first aspect, a method for coding an image is provided as shown in FIG. 6. In FIG. 6, the method 600 comprises generating from the image a residual block having a plurality of residual values using a coding mode 602; selecting a scanning pattern for scanning the residual block depending on the coding mode 604; scanning the residual values according to the scanning pattern 606; and generating a residual value stream from the scanned residual values 608.

In the context of various embodiments, the term “coding” generally refer to a form of cryptogram, for example, entropy coding which is a type of lossless coding to compress digital data by representing frequently occurring patterns with few bits and rarely occurring patterns with more bits. For example, Huffman coding is a type of entropy coding. In the H.264/AVC standard and the HEVC standard, Context-based Adaptive Binary Arithmetic Coder (CABAC), and Context Adaptive Variable Length Coding (CAVLC) may be used.

The term “coding mode” may generally refer to a factor or a parameter used for coding purposes or involved in the coding process. A coding mode may be a block size, a block type or a type of transformation. For example, the coding mode may refer to the prediction mode of the prediction circuit 506 and/or an attribute or parameter (e.g., size) 514 of the transform block of FIG. 5.

As used herein, the term “scanning pattern” generally refer to a scheme or an arrangement of scans or detections. For example, the scanning pattern may contain information on scan directions and/or scan magnitudes and/or scan orientations.

The term “residual value stream” may refer to residual values being arranged in a stream, more specifically, one after another in sequence. A stream is one-dimensional and generally used in sequential or non-parallel transmission, for example, in video transmission. For example, a stream may be a bitstream.

The term “generating” may generally refer but not limited to forming, determining or outputing. In this context, generating a residual block or a residual value stream may require respective functions to be carried out on the respective sources. For example, generating the “residual block” may require taking the resultant difference between a block (from the image) and a predictive block. The resultant difference may be represented in terms of residual values or interchangably referred to as residual coefficients. A residual value may be a numerical value. The difference may be obtained by taking a mathematical subtraction, for example, of a matrix.

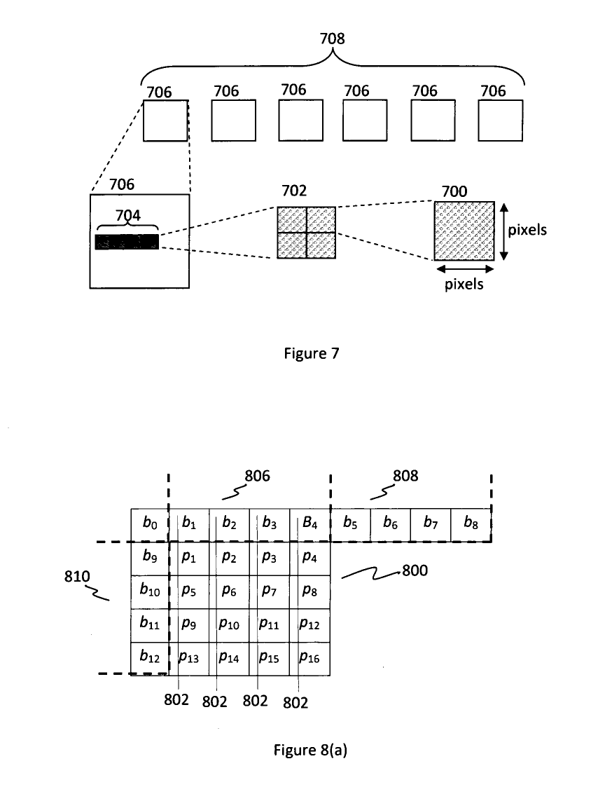

As used herein, with reference to FIG. 7, a block 700 (or interchangably referred to as a source block) may comprise pixels and forms part of a largest coding unit (LCU), a coding unit (CU), a prediction unit (PU) or a transform unit (TU) 702, which is in turn part of a slice 704 taken from an image or a frame 706 of a video sequence 708. The LCU and CU 702 may be considered to have comparable functionalities to a macroblock used in the H.264/AVC standard. A “predictive block” may be obtained by applying a prediction mode to a block 700. A prediction mode may be an inter-prediction mode or an intra-prediction mode. For example, the block 700 and the prediction mode may refer to the block (source) 504 and the prediction mode of the prediction circuit 506 of FIG. 5, respectively.

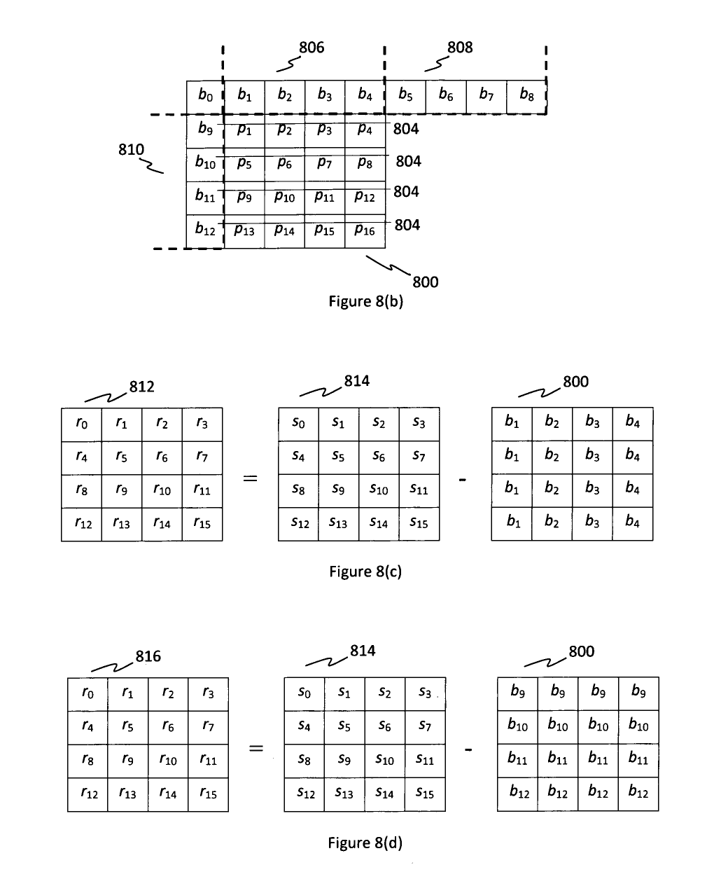

As an example for illustrating purposes only as shown in FIG. 8, a predictive block 800 comprising predictions p₁ to p₁₆ may be obtained utilizing for example but not limited to (a) a vertical intra-prediction mode 802 or (b) a horizontal mode 804 and boundary pixels (b₀ to b₁₂) from adjacent 4×4 blocks 806 (upper block with b₁ to b₄), 808 (diagonal block with b₅ to b₈), 810 (left block with b₉ to b₁₂).

For the vertical (v) intra-prediction mode 802, the predictive block 800 may be provided by pₙ^{v}=b₁ for n=1, 5, 9, 13; pₙ^{v}=b₂ for n=2, 6, 10, 14; pₙ^{v}=b₃ for n=3, 7, 11, 15; pₙ^{v}=b₄ for n=4, 8, 12, 16. Thus, the residual block 812 (FIG. 8(c)) is the difference between the image in parts (or a source block) 814 and the predictive block 800 based on the vertical (v) intra-prediction mode 802.

For the horizontal (h) intra-prediction mode 804, the predictive block 800 may be provided by pₙ^{h}=b₉ for n=1, 2, 3, 4; pₙ^{h}=b₁₀ for n=5, 6, 7, 8; pₙ^{h}=b₁₁ for n=9, 10, 11, 12; pₙ^{h}=b₁₂ for n=13, 14, 15, 16. Thus, the residual block 816 (FIG. 8(d)) is the difference between the image in parts (or a source block) 814 and the predictive block 800 based on the horizontal (h) intra-prediction mode 804. For example, the source block 814 may be refer to the block (source) 504 of FIG. 5; the residual block 812, 816 may refer to the residual block 512 of FIG. 5; the predictive block 800 may refer to the output 508 of FIG. 5; and the vertical intra-prediction mode 802 or the horizontal intra-prediction mode 804 may refer to the prediction mode of the prediction circuit 506 of FIG. 5.

Various embodiments provide a method for coding an image used in video compression. The image may be a digital image represented by a RGB format or a YUV format or a grayscale format. The method according to various embodiments may take a continuous part of the image of specific dimensions and may convert the continuous part of the image into a residual block. The generation of the residual block or the conversion into the residual block is generally based on a mathematical formulation or function, which involves a coding mode as a variable. Based on this coding mode, the method according to various embodiments may also select a scanning pattern for scanning the residual block. The scanning pattern may be of a fixed arrangement and known to both the encoder and the decoder performing the coding and decoding of the image, respectively; thereby not requiring scanning parameters or information on the scanning pattern to be transmitted along with the (coded) compressed data. There may be various choices of fixed arrangements of scanning, selected for use between the encoder and the decoder. These choices may be pre-determined and may be revised or amended to form new choices. Using the selected scanning pattern, the method according to various embodiments may scan or detect or read the residual block to obtain the residual values therein. These residual values in the residual (two-dimensional) block may be arranged into a one-dimensional residual value stream.

In various embodiments, the method 600 may further comprise encoding the residual value stream into an encoded video signal. As used herein, the term “encoding” generally refer to converting or translating using a form of cryptogram. “Encoding” may be interchangably referred to as “coding”. For example, “encoding” may use entropy coding. As an example, “encoding” may be carried out by the coding circuit 518 of FIG. 5.

In various embodiments, encoding may use an arithmetic coding based Context-based Adaptive Binary Arithmetic Coder (CABAC), or a variable length coding based Context Adaptive Variable Length Coding (CAVLC).

In some embodiments, encoding the residual value stream may comprise coding a flag after each zero value is detected from the residual values to signal if the zero value is after a last non-zero value.

As used herein, the “flag” may be an indication or an identifier or a signal. For example, a flag may be represented by a bit or a group of bits. Generally, the flag may be used indicate status, for example a “0” flag may represent a status of non-zero value detection, while a “1” flag may represent a status of zero value detection.

The term “after” may generally refer to “proceeding” as opposed to “preceding”.

For example, at present, when coding the significance map of the residual values (or transform coefficients) using CABAC, after each non-zero coefficient is coded, a flag may be used to signal if it is the last non-zero coefficient. However, if the scanning pattern is used, it may be the case that most of the scanned coefficients are non-zero. In that case, it would be more efficient to code a flag after each zero to signal if it is after the last non-zero coefficient; in such a case, there may be no need to code the last non-zero flag after each non-zero coefficient.

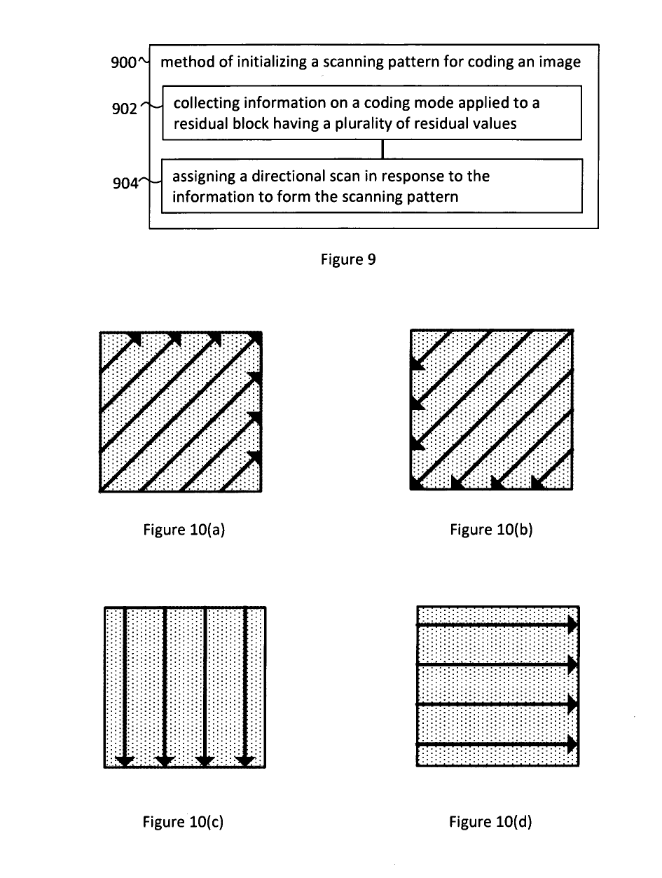

In a second aspect, a method of initializing a scanning pattern for coding an image is provided as shown in FIG. 9. In FIG. 9, the method 900 comprises collecting information on a coding mode applied to a residual block having a plurality of residual values 902; and assigning a directional scan in response to the information to form the scanning pattern 904.

The terms “coding mode”, “residual block” and “scanning pattern” may be defined as above.

In the context of various embodiments, the term “collecting” may refer to gathering or obtaining or receiving or compiling. For example, the information on a coding mode may be collected when a user or a system determines the coding mode. For example, the information may include a name, a description, a reference, a parameter or a representation of the coding mode.

The term “assigning” may generally refer to allocating or alloting upon satisfying certain requirements or conditions. For example, an algorithm may be used in assigning. As used herein, the algorithm may be realized by a computer program (e.g., machine codes or JavaScript programs) or by firmware (e.g., a hard-wired circuit of logic implementation). The algorithm may depend on a set of conditions or may controlled by human intervention, for example, a status overwrite.

As used herein, the term “directional scan” may refer to a course or line along which a scan moves (progresses), points, or lies.

In various embodiments, the scanning pattern may comprise a scan order selected from a group consisting of a “up-right” scan, a “down-left” scan, a “vertical” scan and a “horizontal” scan. The scanning pattern may have a fixed mode-dependent scan order.

In the context of various embodiments, the term “scan order” may generally refer to a directional scan as exemplified above or a sequence in which scans are made.

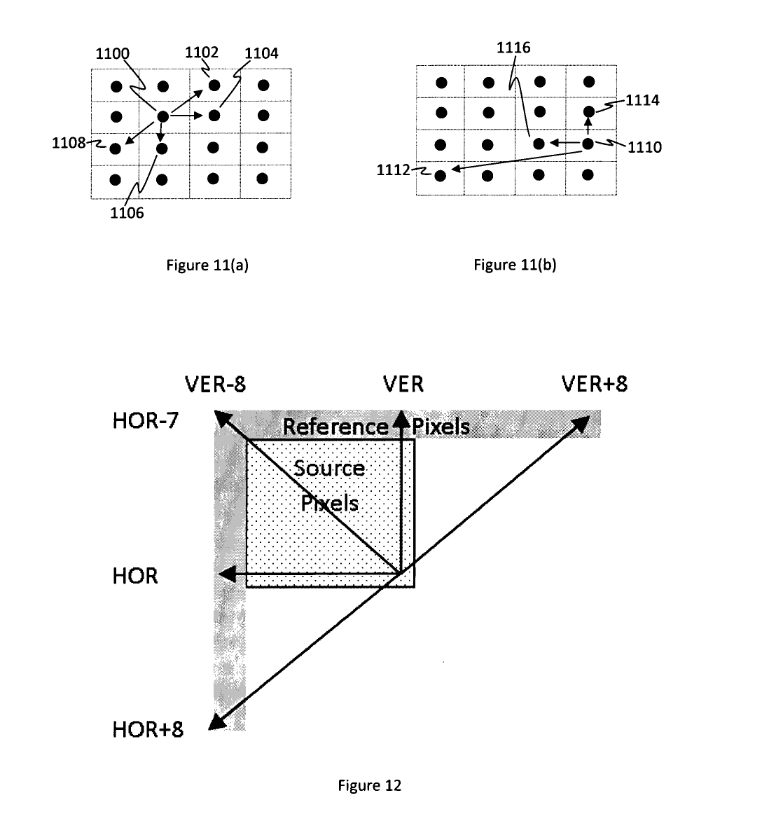

FIG. 10 shows an exemplary representation of (a) “up-right” scans; (b) “down-left” scans; (c) “vertical” scans and (d) “horizontal” scans. The scan lines (or arrows) shown in each of FIGS. 10(a)-10(d) are merely representations of the respective directional scans and are not to be taken to represent the actual number of scan lines. Generally, taking a scan area to be made up of discrete points, for example in a pixelated image, a scan may progress directionally from a point (pixel) 1100 to an adjacent point (adjacent pixel) sharing a common boundary or edge 1102, 1104, 1106, 1108, as shown in FIG. 11(a). In another embodiment, a scan may progress directionally from a point (pixel) 1110 to an non-adjacent point (non-adjacent pixel) 1112, which does not share a common boundary or edge, as shown in FIG. 11(b). The non-adjacent point 1112 may be a beginning of a next scanline with respect to its immediate preceding point 1110 that was scanned. FIG. 11(b) also shows other examples where the vertical scan may be a bottom-to-top scan from point 1110 to point 1114; or the horizontal scan may be a right-to-left scan from point 1110 to point 1116.

In various embodiments, the scan order may be of the same direction as shown, for example, in FIG. 10. The scan order may comprise a wave-front scan. This may allow for better parallelization as there is no need to await preceding scan information for determining and performing a subsequent scan.

In various embodiments, the residual block may comprise intra-prediction residuals. For example, the residual block may comprise differences between the image and a predictive block, the predictive block obtained from using the intra-prediction mode on the image. The intra-prediction mode may be used on a block from the image.

In the context of various embodiments, the term “intra-prediction residuals” refers to residual values that are obtained by first subjecting a block to an intra-prediction mode and subsequently, taking the difference between the block and the output from the intra-prediction mode.

In various embodiments, the scanning pattern may be selected depending on a selection of the coding mode. For example, the coding mode may be selected from a group consisting of a transform block size, an intra-prediction mode and a combination thereof. The selection may, for example, be carried out by an algorithm. The term “algorithm” may be defined as above.

The scanning pattern or the scan order to be used may depend on the intra prediction mode that is used, but unlike conventional scanning methods, there may be no updating of the scans, and therefore, no statistics collection or re-sorting may be necessary. Similarly, no counters would be needed to keep or monitor decisions on the direction of each diagonal scan. Furthermore, a small set of scans may be used, all of which may be easy to implement directly, so there may be no need to store large tables indicating the positions of the scan orders or the coefficient statistics needed to derive the scan order. This may significantly reduce the complexity and the amount of information storage. Regarding firmware, only minimal additional complexity or no additional complexity may occur.

In various embodiments, the intra-prediction may be in a form of a luma prediction or a chroma prediction, representing the luminence level and the colour, respectively. The intra-prediction may be selected from a group consisting of a 64×64 luma prediction, a 32×32 luma prediction, a 32×32 chroma prediction, a 16×16 luma prediction, a 16×16 chroma prediction, a 8×8 luma prediction, a 8×8 chroma prediction, a 4×4 luma prediction, and a 4×4 chroma prediction. In this context, n×n refers to prediction block size.

In various embodiments, the transform block size may be selected from a group consisting of 4×4 pixels, 8×8 pixels, 16×16 pixels and 32×32 pixels.

As used herein, the term “transform block size” may refer to the size of a transform block which is applied to the residual values. Sizes for blocks may generally be referred with respect to pixels.

In various embodiments, the intra-prediction mode comprises a directional intra-prediction mode or a DC intra-prediction mode. FIG. 12 shows an exemplary simplified illustration of intra-prediction modes where only the boundaries such as “HOR+8”, “HOR−7”, “VER−8” and “VER+8”, and mid-points such as “HOR” and “VER” are reflected. Other directional intra-prediction modes (not shown in FIG. 12) may be spatially distributed between the boundaries and may be denoted by “VER+x”, “VER−x”, “HOR+x” and “HOR−x” where x is an offset of 1, or 2, or 3, . . . , or 8. The spatial distribution of these other directional intra-prediction modes may be substantially even. Each directional intra-prediction mode, for example, “VER+8” may be spaced about 45° with respect to “VER” when taken as a reference. As another example, “VER+4” may be spaced about 22.5° with respect to “VER” when taken as a reference.

As an example, for the transform block size of 4×4 pixels, the directional intra-prediction mode may be selected from one of sixteen directional intra-prediction modes. In another example, for the transform block size of 8×8 pixels, or 16×16 pixels, or 32×32 pixels, the directional intra-prediction mode may be selected from one of thirty-three directional intra-prediction modes.

In one embodiment, with reference to FIG. 12, the scan order may comprise

| Intra Prediction Mode(s) | N = 4 | N = 8 | N = 16 | N = 32 |
|---|---|---|---|---|
| DC | DL | DL | DL | DL |
| VER − 8 | UR | UR | UR | UR |
| VER − 7 to VER − 5 | DL | DL | DL | DL |
| VER − 4 to VER + 4 | H | H | DL | DL |
| VER + 5 to VER + 8 | DL | DL | DL | DL |
| HOR − 7 to HOR − 5 | UR | UR | UR | UR |
| HOR − 4 to HOR + 4 | V | V | UR | UR |
| HOR + 5 to HOR + 8 | UR | UR | UR | UR |

where N represents the transform block size, DL represents a “down-left” scan; UR represents a “up-right” scan; H represents a “horizontal” scan; V represents a “vertical” scan; DC represents a DC intra prediction mode; VER±offset represents a vertical±offset directional intra prediction mode, offset being 0, 1, . . . , 8; HOR+offset represents a horizontal+offset directional intra prediction mode, offset being 0, 1, . . . , 8; and HOR−offset represents a horizontal−offset directional intra prediction mode, offset being 1, 2, . . . , 7.

In this embodiment, for example, if the intra-prediction mode “VER−6” is used on a block to obtain a residual block and a 8×8 transform block (i.e., N=8) is applied onto the residual block, then the scanning pattern selected would comprise “down-left” (DL) scans. In this case, the block and the residual block may also typically each have a block size of 8×8 pixels.

To further clarify the selection of scan order, in another example, if the intra-prediction mode “HOR+2” is used on a block to obtain a residual block and a 16×16 transform block (i.e., N=16) is applied onto the residual block, then the scanning pattern selected would have of “up-right” (UR) scan.

In one embodiment, similar with reference to FIG. 12, the scan order may comprise

| Intra Prediction Mode(s) | N = 4 | N = 8 | N = 16 | N = 32 |
|---|---|---|---|---|
| DC | DL | DL | DL | DL |
| VER − 8 | UR | UR | UR | UR |
| VER − 7 to VER − 5 | DL | DL | DL | DL |
| VER − 4 to VER + 4 | H | H | H | H |
| VER + 5 to VER + 8 | DL | DL | DL | DL |
| HOR − 7 to HOR − 5 | UR | UR | UR | UR |
| HOR − 4 to HOR + 4 | V | V | V | V |
| HOR + 5 to HOR + 8 | UR | UR | UR | UR |

where N represents the transform block size, DL represents a “down-left” scan; UR represents a “up-right” scan; H represents a “horizontal” scan; V represents a “vertical” scan; DC represents a DC intra prediction mode; VER±offset represents a vertical±offset directional intra prediction mode, offset being 0, 1, . . . , 8; HOR+offset represents a horizontal+offset directional intra prediction mode, offset being 0, 1, . . . , 8; and HOR−offset represents a horizontal−offset directional intra prediction mode, offset being 1, 2, . . . , 7.

In this embodiment, for example, if the intra-prediction mode “VER−4” is used on a block to obtain a residual block and a 16×16 transform block (i.e., N=16) is applied onto the residual block, then the scanning pattern selected would comprise “horizontal” (H) scans.

In another embodiment, similar with reference to FIG. 12, the scan order may comprise

| Intra Prediction Mode(s) | N = 4 | N = 8 | N = 16 | N = 32 |
|---|---|---|---|---|
| DC | UR | UR | UR | UR |
| VER − 8 | UR | UR | UR | UR |
| VER − 7 to VER − 5 | UR | UR | UR | UR |
| VER − 4 to VER + 4 | H | H | UR | UR |
| VER + 5 to VER + 8 | UR | UR | UR | UR |
| HOR − 7 to HOR − 5 | UR | UR | UR | UR |
| HOR − 4 to HOR + 4 | V | V | UR | UR |
| HOR + 5 to HOR + 8 | UR | UR | UR | UR |

where N represents the transform block size, UR represents a “up-right” scan; H represents a “horizontal” scan; V represents a “vertical” scan; DC represents a DC intra prediction mode; VER±offset represents a vertical±offset directional intra prediction mode, offset being 0, 1, . . . , 8; HOR+offset represents a horizontal+offset directional intra prediction mode, offset being 0, 1, . . . , 8; and HOR−offset represents a horizontal−offset directional intra prediction mode, offset being 1, 2, . . . , 7. This scan order utilizing 3 directional scans are currently adopted as a HEVC design standard.

In this embodiment, for example, if the intra-prediction mode “VER−6” is used on a block to obtain a residual block and a 8x8 transform block (i.e., N=8) is applied onto the residual block, then the scanning pattern selected would comprise “up-right” (UR) scans.

In a different embodiment, similar with reference to FIG. 12, the scan order may comprise

| Intra Prediction Mode(s) | N = 4 | N = 8 | N = 16 | N = 32 |
|---|---|---|---|---|
| DC | UR | UR | UR | UR |
| VER − 8 | UR | UR | UR | UR |
| VER − 7 to VER − 5 | UR | UR | UR | UR |
| VER − 4 to VER + 4 | H | H | H | H |
| VER + 5 to VER + 8 | UR | UR | UR | UR |
| HOR − 7 to HOR − 5 | UR | UR | UR | UR |
| HOR − 4 to HOR + 4 | V | V | V | V |
| HOR + 5 to HOR + 8 | UR | UR | UR | UR |

where N represents the transform block size, UR represents a “up-right” scan; H represents a “horizontal” scan; V represents a “vertical” scan; DC represents a DC intra prediction mode; VER±offset represents a vertical±offset directional intra prediction mode, offset being 0, 1, . . . , 8; HOR+offset represents a horizontal+offset directional intra prediction mode, offset being 0, 1, . . . , 8; and HOR−offset represents a horizontal−offset directional intra prediction mode, offset being 1, 2, . . . , 7.

In this embodiment, for example, if the intra-prediction mode “HOR+6” is used on a block to obtain a residual block and a 16×16 transform block (i.e., N=16) is applied onto the residual block, then the scanning pattern selected would comprise “up-right” (UR) scans.

In another embodiment, similar with reference to FIG. 12, the scan order may comprise

| Intra Prediction Mode(s) | N = 4 | N = 8 | N = 16 | N = 32 |
|---|---|---|---|---|
| DC | DL | DL | DL | DL |
| VER − 8 | DL | DL | DL | DL |
| VER − 7 to VER − 5 | DL | DL | DL | DL |
| VER − 4 to VER + 4 | H | H | DL | DL |
| VER + 5 to VER + 8 | DL | DL | DL | DL |
| HOR − 7 to HOR − 5 | DL | DL | DL | DL |
| HOR − 4 to HOR + 4 | V | V | DL | DL |
| HOR + 5 to HOR + 8 | DL | DL | DL | DL |

where N represents the transform block size, DL represents a “down-left” scan; H represents a “horizontal” scan; V represents a “vertical” scan; DC represents a DC intra prediction mode; VER±offset represents a vertical±offset directional intra prediction mode, offset being 0, 1, . . . , 8; HOR+offset represents a horizontal+offset directional intra prediction mode, offset being 0, 1, . . . , 8; and HOR−offset represents a horizontal−offset directional intra prediction mode, offset being 1, 2, . . . , 7.

In this embodiment, for example, if the intra-prediction mode “HOR+6” is used on a block to obtain a residual block and a 16×16 transform block (i.e., N=16) is applied onto the residual block, then the scanning pattern selected would comprise “down-left” (DL) scans.

In a different embodiment, similar with reference to FIG. 12, the scan order may comprise

| Intra Prediction Mode(s) | N = 4 | N = 8 | N = 16 | N = 32 |
|---|---|---|---|---|
| DC | DL | DL | DL | DL |
| VER − 8 | DL | DL | DL | DL |
| VER − 7 to VER − 5 | DL | DL | DL | DL |
| VER − 4 to VER + 4 | H | H | H | H |
| VER + 5 to VER + 8 | DL | DL | DL | DL |
| HOR − 7 to HOR − 5 | DL | DL | DL | DL |
| HOR − 4 to HOR + 4 | V | V | V | V |
| HOR + 5 to HOR + 8 | DL | DL | DL | DL |

where N represents the transform block size, DL represents a “down-left” scan; H represents a “horizontal” scan; V represents a “vertical” scan; DC represents a DC intra prediction mode; VER±offset represents a vertical±offset directional intra prediction mode, offset being 0, 1, . . . , 8; HOR+offset represents a horizontal+offset directional intra prediction mode, offset being 0, 1, . . . , 8; and HOR−offset represents a horizontal−offset directional intra prediction mode, offset being 1, 2, . . . , 7.

In this embodiment, for example, if the intra-prediction mode “HOR+4” is used on a block to obtain a residual block and a 16×16 transform block (i.e., N=16) is applied onto the residual block, then the scanning pattern selected would comprise “vertical” (V) scans.

In various embodiments, the residual values may be transformed and quantized. In this context, transformed residual values may be referred to as residual values or may be interchangably referred to as “transform coefficients” or “residual transform coefficients”. For example, the residual values may be transformed using discrete cosine transform (DCT). The residual values may be quantized using quantization parameters.

As used herein, the term “transform” may refer to convert from one domain (or representation) into another domain. Transformation or conversion may be performed using a mathematical function, for example, DCT, discrete sine transform (DST), Karhunen-Loeve transform (KLT), and fast Fourier transform (FFT).

In the context of various embodiments, the term “quantized” may refer to being subject to a process that attempts to determine what information may be discarded safely without a significant loss in visual fidelity. The quantization process may inherently be lossy due to estimations such as the many-to-one mapping process. The term “quantization parameter” (QP) refers to a value that regulates how much spatial detail may be saved. For example, when QP is a relatively small value, almost all detail may be retained. As QP is increased, some of the detail may be aggregated resulting in a decrease in the bit rate but at the price of some increase in distortion and some loss of quality.

In various embodiments, the image may comprise a block from a frame of a video sequence.

In other embodiments, the scanning pattern may be configured to operate without a need for updating each scan direction by a scan update and/or for determining each scan direction by a scan counter.

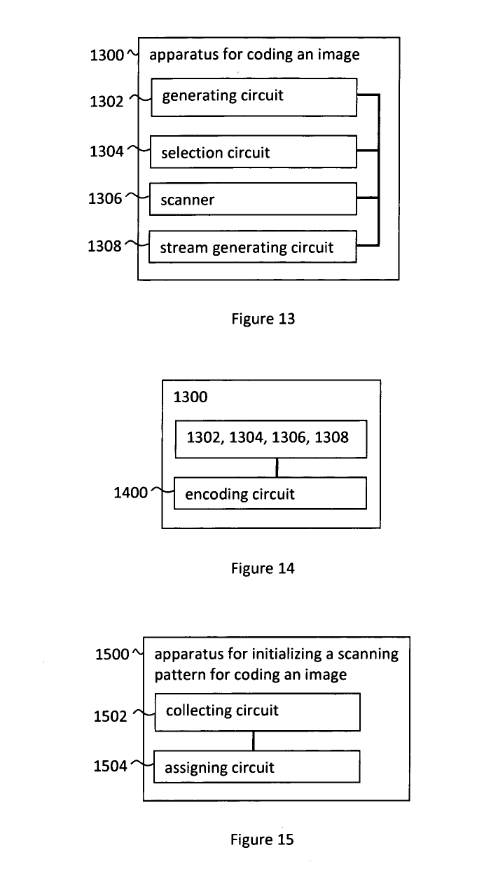

In a third aspect, an apparatus for coding an image is provided as shown in FIG. 13. In FIG. 13, the apparatus 1300 comprises a generating circuit 1302 configured to generate from the image a residual block having a plurality of residual values using a coding mode; a selection circuit 1304 configured to select a scanning pattern for scanning the residual block generated by the generating circuit 1302 depending on the coding mode; a scanner 1306 configured to scan the residual values according to the scanning pattern selected by the selection circuit 1304; and a stream generating circuit 1308 configured to generate a residual value stream from the residual values scanned by the scanner 1306.

The apparatus 1300 may have a memory which stores an indication of a plurality of scanning patterns and the selection circuit 1304 may select from the plurality of scanning patterns depending on the coding mode. For example, the indication may refer to a pointer to a lookup table containing the plurality of scanning patterns, which may be stored in the memory or in an external storage.

In the context of various embodiments, a “circuit” may be understood as any kind of a logic implementing entity, which may be special purpose circuitry or a processor executing software stored in a memory, firmware, or any combination thereof. Thus, in an embodiment, a “circuit” may be a hard-wired logic circuit or a programmable logic circuit such as a programmable processor, e.g. a microprocessor (e.g. a Complex Instruction Set Computer (CISC) processor or a Reduced Instruction Set Computer (RISC) processor). A “circuit” may also be a processor executing software, e.g. any kind of computer program, e.g. a computer program using a virtual machine code such as e.g. Java. Any other kind of implementation of the respective functions which will be described in more detail below may also be understood as a “circuit” in accordance with an alternative embodiment.

As used herein, the terms “image”, “residual values”, “residual value stream”, and “coding” may be defined as above. The terms “generate” and “select” may similarly be defined as for the herein-mentioned terms “generating” and “selecting”, respectively.

In various embodiments, the apparatus 1300 may further comprise an encoding circuit 1400 configured to encode the residual value stream into an encoded video signal as shown in FIG. 14.

The encoding circuit 1400 may use an arithmetic coding based Context-based Adaptive Binary Arithmetic Coder (CABAC), or a variable length coding based Context Adaptive Variable Length Coding (CAVLC). For example, the encoding circuit 1400 may refer to the coding circuit 518 of FIG. 5.

In various embodiments, the encoding circuit 1400 may be configured to code a flag after each zero value is detected from the residual values to signal if the zero value is after a last non-zero value. In the context of various embodiments, the term “flag” and “after” may be defined as above.

In a fourth aspect, an apparatus for initializing a scanning pattern for coding an image is provided as shown in FIG. 15. In FIG. 15, the apparatus 1500 comprises a collecting circuit 1502 configured to collect information on a coding mode applied to a residual block having a plurality of residual values; and an assigning circuit 1504 configured to assign a directional scan in response to the information collected by the collecting circuit 1502 to form the scanning pattern.

In the context of various embodiments, the terms “assign”, “collect” and “directional scan” may be as defined above.

In various embodiments, the scanning pattern may comprise a scan order selected from a group consisting of a “up-right” scan, a “down-left” scan, a “vertical” scan and a “horizontal” scan. The term “scan order” may be as defined above.

In context of various embodiments, the terms “residual block”, “coding mode”, and “scanning pattern” may be defined as above.

In various embodiments, the coding mode may be selected from a group consisting of a transform block size, an intra-prediction mode and a combination thereof.

In context of various embodiments, the terms “transform block size”, and “intra-prediction mode” may be defined as above.

In various embodiments, the residual values may be transformed and quantized. The residual values may be transformed using discrete cosine transform (DCT) or discrete since transform (DST) or Karhunen-Loeve transform (KLT). The residual values may be quantized using quantization parameters.

Various embodiments provide a method for coding an image such that rate-distortion performance of intra prediction residual coding may be improved. The method according to various embodiments may utilize mode-dependent coefficient scanning having similar gains as compared to conventional methods. In comparison, for example, adaptive scan methods greatly increase the decoding complexity, since the residual coefficients statistics have to be updated as each block is decoded. Furthermore, due to the arbitrary scan orders that are used, parallelization of the coding process may be difficult. The method according to various embodiments overcomes the abovementioned difficulties by using a simplified set of scans which allows for parallelization and requires no statistics updating. For example, while improving the rate-distortion performance of coding intra prediction residuals, the method according to various embodiments may be able to avoid at least collecting coefficient statistics, sorting to derive scan orders, storing arbitrary scan orders, and inability to parallelize the entropy coding. The method according to various embodiments has similar compression performance as compared to adaptive scans while requiring much less decoding complexity; thereby abling to achieve the full compression benefits of adaptive scan orders for intra coding at little additional cost for decoder run-time.

As an example, a scheme of scanning pattern referred to as Mode-Dependent Simplified Scans (MDSS), was implemented in the current HEVC Test Model 1 (HM1) reference software, TMuC v0.9. Since the scan order is mode-dependent, there is no need to add any bitstream syntax.

In this example, an all intra coding configuration was used, with Context-adaptive binary arithmetic coding (CABAC) as the entropy coder in the high-efficiency setting. All the HEVC test sequences were used, and coding was done at 4 QP values (22, 27, 32, 37) for each sequence and method. The coding performances of HM1 with and without the MDSS were compared. The coding performance of a known conventional adaptive scanning (QC Scan) was also measured for comparison purposes.

Table 1 below summarizes the Y BD-rate performance of the MDSS scheme compared to the HM1 reference, and also the conventional adaptive scanning compared to the HM 1 reference for all-intra coding.

TABLE 1

| | MDSS vs. HM1 | QC Scan vs. HM1 |
|---|---|---|
| Sequence Class | Y BD-Rate (%) | Y BD-Rate (%) |
| Class A | −0.4 | −0.4 |
| Class B | −0.5 | −0.5 |
| Class C | −1.1 | −1.0 |
| Class D | −1.0 | −0.9 |
| Class E | −1.4 | −1.2 |
| All | −0.9 | −0.8 |
| Run-Time | Compared to | Compared to |
| | Reference | Reference |
| Encoding | 106% | 106% |
| Decoding | 100% | 220% |

From Table 1, it is observed that MDSS was able to match the coding performance of QC Scan, but avoided the doubling of decoding run-time. It was further noted that despite the use of fixed directions for each scan, there was no loss in coding performance.

Entropy coding of the quantized transform coefficients was addressed. The scheme, for example, used in the method according to various embodiments modifies how coefficients may be scanned during the entropy coding process. By using a simple set of scans, it may be possible to improve coding performance by an average of 0.9% BD-Rate, with no significant increase in decoding run-time. Furthermore, the scans may allow for parallelization, which is typically an area of major concern in actual implementations for existing methods and systems.

It may also be possible to apply the MDSS scheme to the variable length coding (VLC)-like Context Adaptive Variable Length Coding (CAVLC) entropy coding. In CAVLC, zig-zag scanning may be done to jointly code the positions of significant coefficients and their values. By choosing an appropriate set of fixed mode-dependent scans, it may be possible to improve coding performance by avoiding coding runs of zero-valued coefficients.

Embodiments described in the context of one of the methods or devices (apparatus) are analogously valid for the other method or device. Similarly, embodiments described in the context of a method are analogously valid for a device (or an apparatus), and vice versa.

As used herein, the term “and/or” includes any and all combinations of one or more of the associated listed items.

In the context of various embodiments, the term “about” or “approximately” as applied to a numeric value encompasses the exact value and a variance of +/−5% of the value.

The phrase “at least substantially” may include “exactly” and a variance of +/−5% thereof. As an example and not limitation, the phrase “A is at least substantially the same as B” may encompass embodiments where A is exactly the same as B, or where A may be within a variance of +/−5%, for example of a value, of B, or vice versa.

While the invention has been particularly shown and described with reference to specific embodiments, it should be understood by those skilled in the art that various changes in form and detail may be made therein without departing from the spirit and scope of the invention as defined by the appended claims. The scope of the invention is thus indicated by the appended claims and all changes which come within the meaning and range of equivalency of the claims are therefore intended to be embraced.

1. A method for coding an image, comprising:
generating from the image a residual block having a plurality of residual values using a coding mode;
selecting a scanning pattern for scanning the residual block depending on the coding mode;
scanning the residual values according to the scanning pattern; and
generating a residual value stream from the scanned residual values.

2-4. (canceled)

5. A method of initializing a scanning pattern for coding an image, the method comprising:
collecting information on a coding mode applied to a residual block having a plurality of residual values; and
assigning a directional scan in response to the information to form the scanning pattern.

6. The method as claimed in claim 1, wherein the scanning pattern comprises a scan order selected from a group consisting of a “up-right” scan, a “down-left” scan, a “vertical” scan and a “horizontal” scan.

7-8. (canceled)

9. The method as claimed in claim 1, wherein the residual block comprises intra-prediction residuals.

10. The method as claimed in claim 1, wherein the scanning pattern is selected depending on a selection of the coding mode.

11. The method as claimed in claim 10, wherein the coding mode is selected from a group consisting of a transform block size, an intra-prediction mode and a combination thereof.

12-13. (canceled)

14. The method as claimed in claim 11, wherein the transform block size is selected from a group consisting of 4×4 pixels, 8×8 pixels, 16×16 pixels and 32×32 pixels.

15. The method as claimed in claim 14, wherein the intra-prediction mode comprises a directional intra-prediction mode or a DC intra-prediction mode.

16. The method as claimed in claim 15, wherein for the transform block size of 4×4 pixels, the directional intra-prediction mode is selected from one of sixteen directional intra-prediction modes.

17. The method as claimed in claim 15, wherein for the transform block size of 8×8 pixels, or 16×16 pixels, or 32×32 pixels, the directional intra-prediction mode is selected from one of thirty-three directional intra-prediction modes.

18. The method as claimed in claim 11, wherein the scan order comprises at least one of:

| Intra Prediction Mode(s) | N = 4 | N = 8 | N = 16 | N = 32 |
|---|---|---|---|---|
| DC | DL | DL | DL | DL |
| VER − 8 | UR | UR | UR | UR |
| VER − 7 to VER − 5 | DL | DL | DL | DL |
| VER − 4 to VER + 4 | H | H | DL | DL |
| VER + 5 to VER + 8 | DL | DL | DL | DL |
| HOR − 7 to HOR − 5 | UR | UR | UR | UR |
| HOR − 4 to HOR + 4 | V | V | UR | UR |
| HOR + 5 to HOR + 8 | UR | UR | UR | UR |
| Intra Prediction Mode(s) | N = 4 | N = 8 | N = 16 | N = 32 |
|---|---|---|---|---|
| DC | DL | DL | DL | DL |
| VER − 8 | UR | UR | UR | UR |
| VER − 7 to VER − 5 | DL | DL | DL | DL |
| VER − 4 to VER + 4 | H | H | H | H |
| VER + 5 to VER + 8 | DL | DL | DL | DL |
| HOR − 7 to HOR − 5 | UR | UR | UR | UR |
| HOR − 4 to HOR + 4 | V | V | V | V |
| HOR + 5 to HOR + 8 | UR | UR | UR | UR |
| Intra Prediction Mode(s) | N = 4 | N = 8 | N = 16 | N = 32 |
|---|---|---|---|---|
| DC | UR | UR | UR | UR |
| VER − 8 | UR | UR | UR | UR |
| VER − 7 to VER − 5 | UR | UR | UR | UR |
| VER − 4 to VER + 4 | H | H | UR | UR |
| VER + 5 to VER + 8 | UR | UR | UR | UR |
| HOR − 7 to HOR − 5 | UR | UR | UR | UR |
| HOR − 4 to HOR + 4 | V | V | UR | UR |
| HOR + 5 to HOR + 8 | UR | UR | UR | UR |
| Intra Prediction Mode(s) | N = 4 | N = 8 | N = 16 | N = 32 |
|---|---|---|---|---|
| DC | UR | UR | UR | UR |
| VER − 8 | UR | UR | UR | UR |
| VER − 7 to VER − 5 | UR | UR | UR | UR |
| VER − 4 to VER + 4 | H | H | H | H |
| VER + 5 to VER + 8 | UR | UR | UR | UR |
| HOR − 7 to HOR − 5 | UR | UR | UR | UR |
| HOR − 4 to HOR + 4 | V | V | V | V |
| HOR + 5 to HOR + 8 | UR | UR | UR | UR |
| Intra Prediction Mode(s) | N = 4 | N = 8 | N = 16 | N = 32 |
|---|---|---|---|---|
| DC | DL | DL | DL | DL |
| VER − 8 | DL | DL | DL | DL |
| VER − 7 to VER − 5 | DL | DL | DL | DL |
| VER − 4 to VER + 4 | H | H | DL | DL |
| VER + 5 to VER + 8 | DL | DL | DL | DL |
| HOR − 7 to HOR − 5 | DL | DL | DL | DL |
| HOR − 4 to HOR + 4 | V | V | DL | DL |
| HOR + 5 to HOR + 8 | DL | DL | DL | DL |

, or

| Intra Prediction Mode(s) | N = 4 | N = 8 | N = 16 | N = 32 |
|---|---|---|---|---|
| DC | DL | DL | DL | DL |
| VER − 8 | DL | DL | DL | DL |
| VER − 7 to VER − 5 | DL | DL | DL | DL |
| VER − 4 to VER + 4 | H | H | H | H |
| VER + 5 to VER + 8 | DL | DL | DL | DL |
| HOR − 7 to HOR − 5 | DL | DL | DL | DL |
| HOR − 4 to HOR + 4 | V | V | V | V |
| HOR + 5 to HOR + 8 | DL | DL | DL | DL |

where N represents the transform block size,
DL represents a “down-left” scan;
UR represents a “up-right” scan;
H represents a “horizontal” scan;
V represents a “vertical” scan;
DC represents a DC intra prediction mode;
VER±offset represents a vertical±offset directional intra prediction mode, offset being 0, 1, . . . , 8;
HOR+offset represents a horizontal+offset directional intra prediction mode, offset being 0, 1, . . . , 8; and
HOR−offset represents a horizontal−offset directional intra prediction mode, offset being 1, 2, . . . , 7.

19-23. (canceled)

24. The method as claimed in claim 1, wherein the residual values are transformed and quantized.

25. The method as claimed in claim 24, wherein the residual values are transformed using discrete cosine transform (DCT) or discrete since transform (DST) or Karhunen-Loeve transform (KLT).

26. The method as claimed in claim 24, wherein the residual values are quantized using quantization parameters.

27-28. (canceled)

29. An apparatus for coding an image, comprising:
a generating circuit configured to generate from the image a residual block having a plurality of residual values using a coding mode;
a selection circuit configured to select a scanning pattern for scanning the residual block generated by the generating circuit depending on the coding mode;
a scanner configured to scan the residual values according to the scanning pattern selected by the selection circuit; and
a stream generating circuit configured to generate a residual value stream from the residual values scanned by the scanner.

30-33. (canceled)

34. The apparatus as claimed in claim 29, wherein the scanning pattern comprises a scan order selected from a group consisting of a “up-right” scan, a “down-left” scan, a “vertical” scan and a “horizontal” scan.

35-36. (canceled)

37. The apparatus as claimed in claim 29, wherein the residual block comprises intra-prediction residuals.

38. The apparatus as claimed in claim 29, wherein the scanning pattern is selected depending on the selection of the coding mode.

39. The apparatus as claimed in claim 38, wherein the coding mode is selected from a group consisting of a transform block size, an intra-prediction mode and a combination thereof.

40-41. (canceled)

42. The apparatus as claimed in claim 39, wherein the transform block size is selected from a group consisting of 4×4 pixels, 8×8 pixels, 16×16 pixels and 32×32 pixels.

43. The apparatus as claimed in claim 42, wherein the intra-prediction mode comprises a directional intra-prediction mode or a DC intra-prediction mode.

44. The apparatus as claimed in claim 43, wherein for the transform block size of 4×4 pixels, the directional intra-prediction mode is selected from one of sixteen directional intra-prediction modes.

45. The apparatus as claimed in claim 43, wherein for the transform block size of 8×8 pixels, or 16×16 pixels, or 32×32 pixels, the directional intra-prediction mode is selected from one of thirty-three directional intra-prediction modes.

46. The apparatus as claimed in claim 39, wherein the scan order comprises at least one of:

| Intra Prediction Mode(s) | N = 4 | N = 8 | N = 16 | N = 32 |
|---|---|---|---|---|
| DC | DL | DL | DL | DL |
| VER − 8 | UR | UR | UR | UR |
| VER − 7 to VER − 5 | DL | DL | DL | DL |
| VER − 4 to VER + 4 | H | H | DL | DL |
| VER + 5 to VER + 8 | DL | DL | DL | DL |
| HOR − 7 to HOR − 5 | UR | UR | UR | UR |
| HOR − 4 to HOR + 4 | V | V | UR | UR |
| HOR + 5 to HOR + 8 | UR | UR | UR | UR |
| Intra Prediction Mode(s) | N = 4 | N = 8 | N = 16 | N = 32 |
|---|---|---|---|---|
| DC | DL | DL | DL | DL |
| VER − 8 | UR | UR | UR | UR |
| VER − 7 to VER − 5 | DL | DL | DL | DL |
| VER − 4 to VER + 4 | H | H | H | H |
| VER + 5 to VER + 8 | DL | DL | DL | DL |
| HOR − 7 to HOR − 5 | UR | UR | UR | UR |
| HOR − 4 to HOR + 4 | V | V | V | V |
| HOR + 5 to HOR + 8 | UR | UR | UR | UR |
| Intra Prediction Mode(s) | N = 4 | N = 8 | N = 16 | N = 32 |
|---|---|---|---|---|
| DC | UR | UR | UR | UR |
| VER − 8 | UR | UR | UR | UR |
| VER − 7 to VER − 5 | UR | UR | UR | UR |
| VER − 4 to VER + 4 | H | H | UR | UR |
| VER + 5 to VER + 8 | UR | UR | UR | UR |
| HOR − 7 to HOR − 5 | UR | UR | UR | UR |
| HOR − 4 to HOR + 4 | V | V | UR | UR |
| HOR + 5 to HOR + 8 | UR | UR | UR | UR |
| Intra Prediction Mode(s) | N = 4 | N = 8 | N = 16 | N = 32 |
|---|---|---|---|---|
| DC | UR | UR | UR | UR |
| VER − 8 | UR | UR | UR | UR |
| VER − 7 to VER − 5 | UR | UR | UR | UR |
| VER − 4 to VER + 4 | H | H | H | H |
| VER + 5 to VER + 8 | UR | UR | UR | UR |
| HOR − 7 to HOR − 5 | UR | UR | UR | UR |
| HOR − 4 to HOR + 4 | V | V | V | V |
| HOR + 5 to HOR + 8 | UR | UR | UR | UR |
| Intra Prediction Mode(s) | N = 4 | N = 8 | N = 16 | N = 32 |
|---|---|---|---|---|
| DC | DL | DL | DL | DL |
| VER − 8 | DL | DL | DL | DL |
| VER − 7 to VER − 5 | DL | DL | DL | DL |
| VER − 4 to VER + 4 | H | H | DL | DL |
| VER + 5 to VER + 8 | DL | DL | DL | DL |
| HOR − 7 to HOR − 5 | DL | DL | DL | DL |
| HOR − 4 to HOR + 4 | V | V | DL | DL |
| HOR + 5 to HOR + 8 | DL | DL | DL | DL |

, or

| Intra Prediction Mode(s) | N = 4 | N = 8 | N = 16 | N = 32 |
|---|---|---|---|---|
| DC | DL | DL | DL | DL |
| VER − 8 | DL | DL | DL | DL |
| VER − 7 to VER − 5 | DL | DL | DL | DL |
| VER − 4 to VER + 4 | H | H | H | H |
| VER + 5 to VER + 8 | DL | DL | DL | DL |
| HOR − 7 to HOR − 5 | DL | DL | DL | DL |
| HOR − 4 to HOR + 4 | V | V | V | V |
| HOR + 5 to HOR + 8 | DL | DL | DL | DL |

where N represents the transform block size,
DL represents a “down-left” scan;
UR represents a “up-right” scan;
H represents a “horizontal” scan;
V represents a “vertical” scan;
DC represents a DC intra prediction mode;
VER±offset represents a vertical±offset directional intra prediction mode, offset being 0, 1, . . . , 8;
HOR+offset represents a horizontal+offset directional intra prediction mode, offset being 0, 1, . . . , 8; and
HOR−offset represents a horizontal−offset directional intra prediction mode, offset being 1, 2, . . . , 7.

47-51. (canceled)

52. The apparatus as claimed in claim 29, wherein the residual values are transformed and quantized.

53. The apparatus as claimed in claim 52, wherein the residual values are transformed using discrete cosine transform (DCT) or discrete since transform (DST) or Karhunen-Loeve transform (KLT).

54. The apparatus as claimed in claim 52, wherein the residual values are quantized using quantization parameters.

55-56. (canceled)
